(19) United States
(12) Patent Application Publication
(10) Pub. No.: US 2008/0176572 A1
(43) Pub. Date: Jul. 24, 2008

(54) METHOD OF HANDOFF

(75) Inventor: Dan Forsberg, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/964,656

(22) Filed: Dec. 26, 2007

Related U.S. Application Data
(60) Provisional application No. 60/882,489, filed on Dec. 28, 2006.

(51) Int. Cl. H04Q 7/20

(52) U.S. Cl. 455/438

(57) ABSTRACT

A method of handoff of user equipment is provided. A code is generated in a mobility management entity. A handoff message is sent from a base station to a user plane function, said message including said code. The handoff message is verified in said user plane function using said code.

### FIELD OF THE INVENTION

The present invention relates to a method of handoff for user equipment changing from base station to another.

### BACKGROUND OF THE INVENTION

A communication system is a facility which enables communication between two or more entities such as user terminal equipment and/or network entities as the nodes associated with a communication system. The communication may comprise, for example, communication of voice, electronic mail (email), text messages, packet data, voice-over-IP VoIP, or the like. The communication may be provided by a fixed line and/or wireless communication interface.

A feature of wireless communications system is that they provide mobility for the user thereof. An example of communications systems providing wireless communication are public land mobile networks (PLMN). An example of the fixed line system is a public switched telephone network (PSTN). A communications system typically operates in accordance with a given standard or specification which sets out what the various elements of the system are permitted to do and how that should be achieved. For example, the standard or the specification may define if the user, or more precisely user equipment, is provided with a circuit switched server or a packet switched server or both. Communication protocol and/or parameters which are be used for the connection are also typically defined. For example, the manner in which communications should be implemented between the user and the elements of the communication network is typically based on a pre-defined communication protocol. In other words, a specific set of rules on which the communication can be based need to be defined to enable communication.

Wireless communications systems typically work on a cellular basis. A user equipment is free to move. When the user equipment is in one location, it is connected to a given base station. As the user moves, it changes the base station to which it is connected. This is referred to as “handoff” or “handover”.

Some previous proposals for handoff have been vulnerable to malicious attacks, for example between the new base station and an upstream network entity.

It is an aim of embodiments of the present invention to address or at least mitigate the above-mentioned problems.

### SUMMARY OF THE INVENTION

According to one aspect of the present invention, there is provided a method of handoff of user equipment comprising:
generating in a mobility management entity a code;
sending a handoff message from a base station to a user plane function, said message including said code;
verifying said handoff message in said user plane function using said code.

According to another aspect of the present invention, there is provided a system comprising:
mobility management entity configured to generate a code;
a base station configured to send a handoff message to a user plane function, said message including said code;
a user plane function configured to verify said handoff message using said code.

According to another aspect of the invention, there is provided a mobility management entity comprising:
a code generator, said code generator arranged to generate a code;
a transmitter for sending said code to at least one of user plane function and a base station for use in handing off.

According to another aspect of the invention, there is provided a mobility management entity comprising:
means for generating a code;
transmitting means for sending said code to at least one of said user plane function and a base station for use in handing off.

According to another aspect of the invention, there is provided a method of handoff of user equipment comprising:
sending a handoff message from a base station to at least one of a user plane function and a mobility management entity, said message being encoded by a code, said code comprising at least one radio link layer key; and
verifying said handoff message in at least one of said user plane function and said mobility management entity, using said code.

According to another aspect of the invention, there is provided a system comprising:
a base station configured to send a handoff message from a base station to at least one of a user plane function and a mobility management entity, said message being encoded by a code, said code comprising at least one radio link layer key; and
a user plane function configured to verify said handoff message, using said code.

According to another aspect of the invention, there is provided a system comprising:
a base station configured to send a handoff message from a base station to at least one of a user plane function and a mobility management entity, said message being encoded by a code, said code comprising at least one radio link layer key; and
a mobility management entity configured to verify said handoff message, using said code
According to another aspect of the invention, there is provided a base station comprising:
means for sending a handoff message to at least one of a user plane function and a mobility management entity, said message being encoded by a code, said code comprising at least one radio link layer key.

According to another aspect of the invention, a base station configured to send a handoff message to at least one of user plane function and a mobility management entity, said message being encoded by a code, said code comprising at least one radio link layer key.

According to another aspect of the invention, there is provided a method of handoff of user equipment comprising:
generating in a user plane function a code;
sending a handoff message from a base station to a mobility management entity, said message including said code;
verifying said handoff message in said mobility management function using said code.

### BRIEF DESCRIPTION OF THE DRAWINGS

For a better understanding of the present invention and as to how the same may be carried into effect, reference will now be made by way of example to the accompanying drawings in which:

FIG. 1 schematically shows a network in which embodiments of the present invention may be implemented;

FIG. 2a shows a flow diagram of a first method embodying the present invention;

FIG. 2b shows a flow diagram of a second method embodying the present invention;

FIG. 3 shows schematically a mobile management entity embodying the present invention; and

FIG. 4 shows a flow diagram of a third method embodying the present invention.

### DETAILED DESCRIPTION OF EMBODIMENTS OF THE INVENTION

Embodiments of the invention maybe used in the so called SAE/LTE 3GPP System architecture evolution/Long Term Evolution currently being proposed. However embodiments of the invention are not limited to this and can be used in any suitable system.

Embodiments of the present invention can be used in any suitable communications network where a user equipment needs to move from one base station to another. It should be appreciated that the user equipment can take any suitable form. By way of example only, the user equipment may comprise a mobile telephone, communication device portable computer, PDA or any other device incorporating a wireless communication facility which can be used to communicate data in one form or another.

In this document, the term “base station” is used. It should be appreciated that different communication standards use different names to refer to an entity providing a similar function. In general, the base station has a wireless connection to user equipment. In for example, in the 3GPP (third generation partnership project) standards, the base station is sometimes referred to as “Node B”. It is also currently being proposed, for example as described in 3GPPR TR 25.912 an evolved Node B (eNB). Typically, the eNBs may be smaller and have lower costs as compared to more traditional Node Bs. Thus, embodiments of the present invention are applicable to handoff between base stations, Node Bs, eNBs or any other similar entity. The term base station is intended to encompass at least these alternatives.

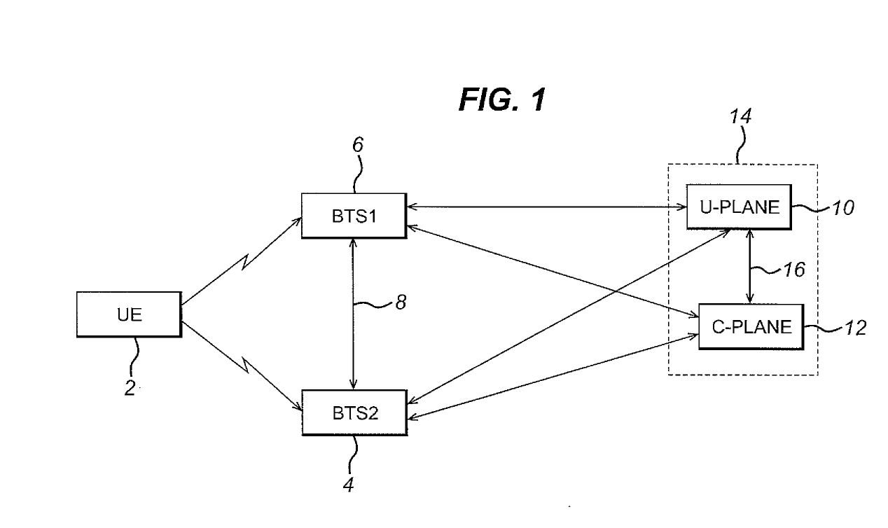

Referring back to FIG. 1 which shows schematically the entities used in embodiments of the present invention, the user equipment 2 is arranged to be able to communicate with a base station 4 or 6 via a wireless link. Generally, the user equipment will communicate with a single base station at a time and handoff to the next base station. Handoff is generally required when the user equipment moves. However, there may be other circumstances in which handoff is required, for example when there are a number of potential base stations available at the current location of the user equipment and the currently used base station becomes overloaded. Embodiments of the present invention can also be used where a user equipment is in communication with two or more base stations and the user is handing off one of those base stations to another.

The base stations 4 and 6 are arranged to communicate directly with one another via link 8. This direct communication may be directly between the two base stations. However, in alternative embodiments of the present invention, the two base stations may be connected together via at least one other entity, for example a base station controller or radio network controller or the like.

The base stations 4 and 6 are each arranged to be connected to two entities. The first entity is a U-plane entity or UPE10 (User plane entity). The base stations 4 and 6 are also arranged to be connected to a control plane (C-plane) entity 12 which will be referred to in this document as a mobility management entity MME. The user plane entity 10 and the MME 12 may be provided in separate devices but in some embodiments of the present invention will be included in a single device 14. The user plane entity 10 is arranged to communicate with the MME 12 via connection 16. Where the two entities are in the same device, the connection 16 will be an internal connection. The user plane entity 10 is used for, for example packet data, such as IP packets. For example, the user plane entity can be used for voice over IP packets. The control plane entity is used for the control of signaling.

Embodiments of the present invention are arranged to secure the path switch message from the base station to the user plane entity 10. In the scenario that a path switch message i.e. a message for changing from one base station to another, goes from the base station which is newly connected to the user equipment directly to the user plane entity 10. This message needs to be protected in order to prevent attackers from sending false path switch messages to the user plane entity.

Embodiments of the present invention are such that the mobile management entity 12 is able to provide an authentication token or one time password for the base station. The authentication token or password is such that it can only be used once or for one handoff before it expires or becomes invalid.

Embodiments of the present invention have the MME 12 and the user plane entity 10 sharing some keys. In general terms, the MME creates an authentication token which is based on the base station identity and a sequence number. The base station identity may be that of the base station to which the user equipment is currently connected, that is the base station from which the user equipment is to be handed off. The user plane entity can verify the path switch message if it can verify that the corresponding base station and the sequence number are correct based on the authentication token.

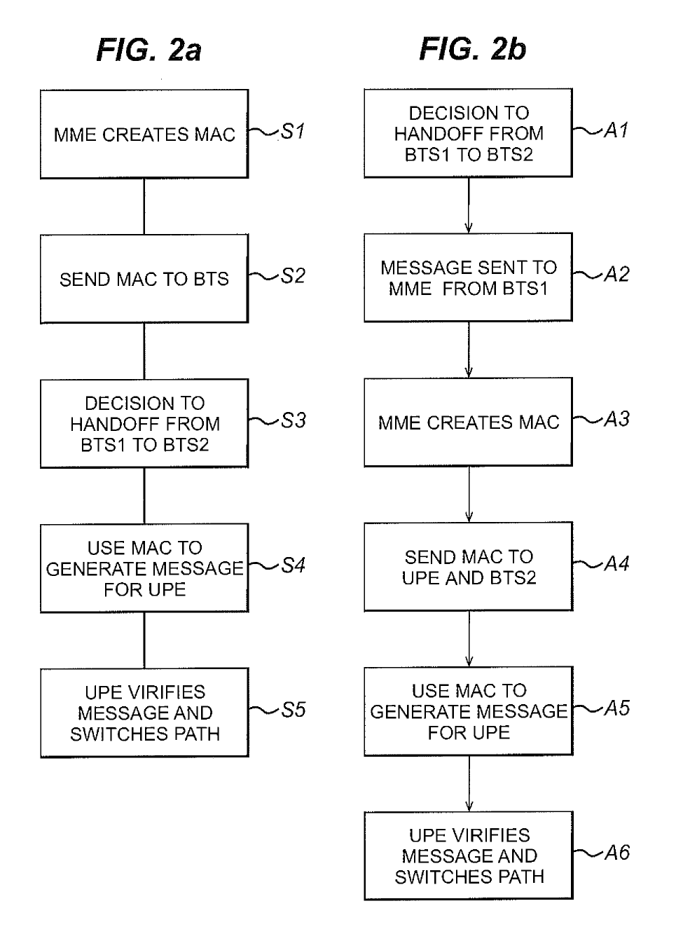

Reference is made to FIG. 2a which schematically shows a first method embodying the present invention. It should be appreciated that the FIG. 2a does not necessarily show all of the steps for embodiments of the present invention. In some implementations, there may be additional steps or signaling additionally included. There maybe addition layers of encryption or signing in some embodiments of the invention. In alternative embodiments of the invention, the steps may be carried out in a different order.

In step S1, the MME will create a so-called message authentication code MAC. The authentication code will be a function of the following: a shared secret key Kup, a unique sequence number for the handoff, the identity of the first base station. The shared secret key Kup is a key which is known both to the user plane entity and the MME. The shared secret key can be created by either the user plane entity or the MME or any other suitable entity. However, the shared secret key is known by both of these entities. Accordingly, a different sequence number would be used for a subsequent hand off as an input parameter to a function producing the MAC. In preferred embodiments of the present invention, the function used is a hash function. In alternative embodiments of the present invention, the function may also use the user equipment identity as an input parameter. In some embodiments of the present invention, the base station identity could be omitted and instead the identity of the user equipment may be relied on.

In step S2, the MAC is sent to the base station to which the user equipment is currently connected via a secure connection. In one embodiment of the invention, the UPE will also be capable of calculating the MAC as it will have the same required information available to it as the MME. This MAC can be calculated in advance by the UPE or when the UPE needs to verify a message it has received, using the MAC. In the alternative, the MME can provide the calculated MAC to the UPE. This may be done via a secure connection between the MME and the UPE, that is connection 16.

In step S3, a decision is made to handoff from base station 1 to base station 2. Any suitable entity may make this decision. This for example may be made by the first base station, the second base station, the user equipment, a combination of those entities or any other suitable entity.

In step S4, the BTS uses the MAC to generate a message for the user plane entity. That generated message is then sent to the user plane entity. This is in step 5. The message sent by the BTS is effectively a hand off message advising that the connection is to be switched from going via the first base station to going via that the second base station. In one embodiment of the invention, the BTS sending the message is the BTS to which the user equipment is currently connected. In another embodiment of the invention, the BTS will be the BTS to which the user equipment is to be handed off to. This will require the BTS to which the user equipment is to be handed off to have received the MAC via a secure connection, for example from the current serving base station.

In step S5, the user plane entity verifies the message received from the base station BTS2. The UPE is able to verify the message using the version of the MAC which it has generated itself or which it has received directly from the MME 12. Once the user plane entity has verified the authenticity of the message, the UPE switches the path from the first base station to the second base station. In other words, the user plane entity is able to communicate with the user equipment via the second base station.

It should be appreciated that the connection for the control plane entity between the user equipment and the MME 12 can be switched once the MME has received a handoff message from the base station. This may take place before, after or at the same time that the UPE switches the connection.

Once the MAC has been used once, the MME is arranged to calculate the next MAC, in preferred embodiments of the invention. It should be appreciated that the connection from the user equipment to the respective base station and from the respective base station to the UPE or MME can be regarded as secure tunnels.

The above described embodiment has the advantage that the user equipment does not have to provide an authentication token. Furthermore, no network domain security or internet protocol is required between the base station and user plane entity. Embodiments of the present invention make use of the fact that a shared key can be provided between the user plane entity and the MME.

In one modification to the invention, the MAC can be created after a handoff decision has been made. In those circumstances the identity of the base station to which the user equipment is to be handed off to may be used in the generation of the MAC instead of the base station identity from which the user equipment was handed off from. FIG. 2b shows a modified method embodying the present invention. This embodiment may be applied for example where the MME controls the handoff decisions and the eNB controls the UPE

In step A1, a decision is made to handoff from base station 1 to base station 2.

In step A2, a message is sent to the MME that a hand off decision has been made. This will be sent by the first base station BTS1 which has a secure connection with the MME. This first base station is the base station from which the connection is to be handed off.

In step A3, the MME will create the MAC.

In step A4, the MAC is sent to the user plane equipment. This will be done via a secure connection between the MME and the UPE, that is connection 16. The MAC is also sent to second base station BTS2, this being the base station to which the connection is to be handed off. Alternatively the UPE may separate determine the MAC as described in relation to FIG. 2a.

The second BTS uses the MAC to generate a message for the user plane entity. That generated message is then sent to the user plane entity. This is in step A5. The message sent by the BTS2 is effectively a hand off message advising that the connection is to be switched from going via the first base station to going via that the second base station.

In step A6, the user plane entity verifies the message received from the second base station BTS2 and switches the path from the first base station to the second base station. In other words, the user plane entity is able to communicate with the user equipment via the second base station.

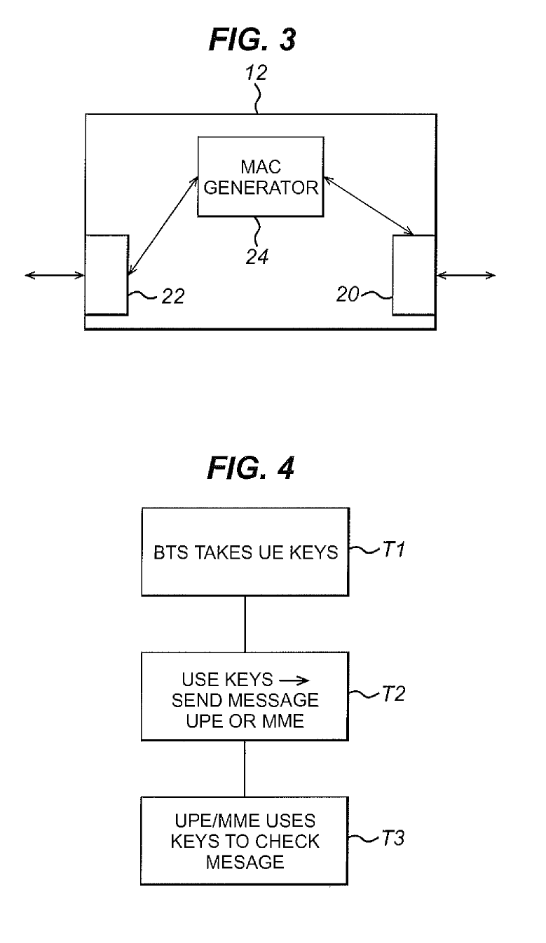

FIG. 3 schematically shows the MME used in the first embodiment of the present invention. The MME 12 has a first functionality 20 which is arranged to transmit and/or receive information/messages from the user plane entity 10. The MME 12 also has a second functionality 22 which is arranged to receive and/or transmit messages/information to the base stations. In the diagram of FIG. 3, the first and second functionalities 20 and 22 are shown as separate entities. It should be appreciated that a single functionality can provide both the functionality of the first functionality 20 and of the second functionality 22.

The MME has a MAC generator 24 which is able to generate the message authentication code. The MAC generator receives the base station identities via the second functionality. The shared secret key which is shared with the user plane entity may be received from the user plane entity or may be generated in the MME and send to the user plane entity. In the embodiment where the shared key is generated in the MME, that shared key can be generated in the MAC generator 24. When the MAC code is generated, it will be sent to the first and second functionalities 20 and 22 for sending to the respective base station and user plane entity.

Reference will now be made to FIG. 4 which shows an alternative embodiment of the present invention. In this alternative, there is another possibility for protecting the “path switch” or handoff message. In particular, the user equipment specific keys between the BTS and the UE are used to sign the handoff message towards the user plane entity 10 and MME 12. These keys are shared secrets. In this embodiment, the base station uses existing keys and does not need to get or have a new key.

Reference is made to FIG. 4 which shows schematically the flow in this alternative embodiment. The base station takes the UE specific radio link protection keys. In one embodiment of the present invention this may be the IKrrc and optionally also CKrrc. The IK key is used for signing and the CK key is used for encryption. RRC refers to the radio resource control. In other words, IKrrc and CKrrc are used for providing protection for the radio link communication between the UE and the base station during normal communication. This is the base station to which the call is to be handed off or the base station that the call is handed off from. These keys can be received either from the MME in an initial attachment message or from the previous base station i.e. BTS1 to which the user equipment was connected.

In step T2, the base station 2 uses the radio link layer protection keys to sign and/or encrypt a message which is sent to the UPE and/or MME. In the alternative, the base station could be used to create a MAC code which is applied to the path switch message that is sent to the UPE or MME. The message authentication code could take a similar form to that described in the previous embodiment, that a hash or similar function of one or more of a shared secret key which in this case could be the IKrrc and/or CKrrc, optionally a unique sequence number for the handoff, at least one base station identity and the user equipment identity.

In step T3, the user plane entity and/or MME uses the radio link layer specific keys, of which it would be aware in order to check the signature and optionally decrypt the message sent to it from the base station. In this way, the UPE and MME can confidently switch the connections to the new base station i.e. BTS2 confident that there is no malicious attack.

In the second embodiment, the MME does not need to provide the authentication code, credential token for the user equipment serving base station. In this embodiment, the MME provides the radio link layer protection key material for the UPE so that the UPE can check the MAC/signature baser on the key material. In other words, the MME provides via a secure connection, the UE specific radio link layer protection keys to the UPE.

It should be appreciated that the MME can be at least partially implemented by computer software.

In one modification, the MME can be at least partially implemented in the user equipment.

Embodiments of the present invention also relate to computer programs for achieving embodiments of the invention. One or more of the steps of the methods shown in Figures and/or discussed may be implemented by a computer program. That computer program may be provided on a computer readable medium.

1. A method of handoff of user equipment comprising:
generating in a mobility management entity a code;
sending a handoff message from a base station to a user plane function, said message including said code;
verifying said handoff message in said user plane function using said code.

2. A method as claimed in claim 1, wherein said code comprises a hash function.

3. A method as claimed in claim 1, wherein said code is valid for a single handoff.

4. A method as claimed in claim 1, wherein said code is a function of at least one of:
a shared secret between said mobility management entity and said user plane function; identity of a base station from which user equipment is to be handed off; an identity of a base station to which said user equipment is to be handed off; and user equipment identity.

5. A method as claimed in claim 1, wherein the sending of the handoff message is from one of a base station to which said user equipment is to be handed off and a base station from which said user equipment is to be handed off.

6. A method as claimed in claim 1, comprising generating in said user plane functionality said same code.

7. A method as claimed in claim 1, comprising sending from said mobility management entity to said user plane function said code.

8. A method as claimed in claim 1, comprising sending from said mobility management entity to said user plane function said code via a secure connection.

9. A method as claimed in claim 1, comprising sending said code from said mobility management entity to said base station.

10. A method as claimed in claim 1, comprising sending a handoff notification message from a base station to the mobility management entity.

11. A method as claimed in claim 1, wherein in response to verifying the handoff message, said user plane entity switches a connection from a base station from which the user equipment is to be handed off to a base station to which the user equipment is to be handed off.

12. A method as claimed in claim 1, wherein said code is generated prior a decision about handoff being made.

13. A system comprising:
mobility management entity configured to generate a code;
a base station configured to send a handoff message to a user plane function, said message including said code;
a user plane function configured to verify said handoff message using said code.

14. A system as claimed in claim 13, wherein said code comprises a hash function.

15. A system as claimed in claim 13, wherein said code is valid for a single handoff.

16. A system as claimed in claim 13, wherein said code is a function of at least one of:
a shared secret between said mobility management entity and said user plane function; an identity of a base station from which user equipment is to be handed off; an identity of a base station to which said user equipment is to be handed off; and user equipment identity.

17. A mobility management entity comprising:
a code generator, said code generator arranged to generate a code;
a transmitter for sending said code to at least one of user plane function and a base station for use in handing off.

18. A mobility management entity comprising:
means for generating a code;
transmitting means for sending said code to at least one of said user plane function and a base station for use in handing off.

19. A method of handoff of user equipment comprising:
sending a handoff message from a base station to at least one of a user plane function and a mobility management entity, said message being encoded by a code, said code comprising at least one radio link layer key; and
verifying said handoff message in at least one of said user plane function and said mobility management entity, using said code.

20. A method as claimed in claim 19, wherein said at least one radio link layer key comprises at least one of a signing key and an encryption key.

21. A method as claimed in claim 19, wherein said code comprises at least one radio link layer key associated with said user equipment.

22. A method as claimed in claim 19, comprising using in said base station said code to at least one of sign and encrypt said message.

23. A method as claimed in claim 19, comprising generating said code from said at least one radio link layer key.

24. A method as claimed in claim 19, comprising generating said code using a hash function

25. A system comprising:
a base station configured to send a handoff message from a base station to at least one of a user plane function and a mobility management entity, said message being encoded by a code, said code comprising at least one radio link layer key; and
a user plane function configured to verify said handoff message, using said code.

26. A system comprising:
a base station configured to send a handoff message from a base station to at least one of a user plane function and a mobility management entity, said message being encoded by a code, said code comprising at least one radio link layer key; and
a mobility management entity configured to verify said handoff message, using said code

27. A base station comprising:
means for sending a handoff message to at least one of a user plane function and a mobility management entity, said message being encoded by a code, said code comprising at least one radio link layer key.

28. A base station configured to send a handoff message to at least one of user plane function and a mobility management entity, said message being encoded by a code, said code comprising at least one radio link layer key.

29. A method of handoff of user equipment comprising:
generating in a user plane function a code;
sending a handoff message from a base station to a mobility management entity, said message including said code;
verifying said handoff message in said mobility management function using said code.
